(19) United States
(12) Patent Application Publication
(10) Pub. No.: US 2024/0157550 A1
(43) Pub. Date: May 16, 2024

(54) REAL-TIME ROBOTICS CONTROL FRAMEWORK WITH CUSTOM REACTIONS

(71) Applicant: Intrinsic Innovation LLC, Mountain View, CA (US)

(72) Inventors: Andre Gaschler, Munich (DE); Nils Berg, Karlsruhe (DE); Gregory J. Prisament, East Palo Alto, CA (US)

(21) Appl. No.: 17/986,696

(22) Filed: Nov. 14, 2022

(51) Int. Cl. B25J 9/16

(52) U.S. Cl. CPC B25J 9/163; B25J 9/161

(57) ABSTRACT

Methods, systems, and apparatus, including computer programs encoded on computer storage media, for controlling a robot. One of the methods includes: receiving user input that specifies: (i) a real-time session with a robot having multiple parts, (ii) multiple actions, and (iii) at least one custom reaction that represents a condition under which a first action triggers a real-time change in behavior involving a second action; generating control parameters from the user input and providing the control parameters to a real-time robotics control layer; and executing, by the real-time robotics control layer, the control parameters including, at each tick of a real-time control cycle: executing one or more respective commands for each action, determining whether the condition of the first action is satisfied, and in response to determining that the condition of the first action is satisfied, triggering the real-time change in behavior involving the second action.

### BACKGROUND

This specification relates to frameworks for software control systems.

Real-time software control systems are software systems that must execute within strict timing requirements to achieve normal operation. The timing requirements often specify that certain actions must be executed or outputs must be generated within a particular time window in order for the system to avoid entering a fault state. In the fault state, the system can halt execution or take some other action that interrupts normal operation. Such real-time software control systems are often used to control physical machines that have high precision and timing requirements. As one example, a workcell of industrial robots can be controlled by a real-time software control system that requires each robot to repeatedly receive commands at a certain frequency, e.g., 1, 10, or 100 kHz. If one of the robots does not receive a command during one of the periodic time windows, the robot can enter a fault state by halting its operation or by automatically executing a recovery procedure to return to a maintenance position. In this specification, a workcell is the physical environment in which a robot will operate. Workcells have particular physical properties, e.g., physical dimensions that impose constraints on how robots can move within the workcell.

Due to such timing requirements, software control systems for physical machines are often implemented by closed software modules that are configured specifically for highly-specialized tasks. For example, a robot that picks components for placement on a printed circuit board can be controlled by a closed software system that controls each of the low-level picking and placing actions.

### SUMMARY

This specification describes a real-time robotics control framework that provides a unified platform for achieving multiple new capabilities for custom real-time control. As one example, the techniques described in this specification allow a user to define custom real-time reactions associated with multiple actions that each define a motion of a particular part of the robot. The custom real-time reactions can represent a condition under which a first action (e.g., associated with a first part of the robot) triggers a real-time change in behavior involving a second action (e.g., associated with a second, different part of the robot). Generally, a reaction can depend on multiple real-time actions being in a particular state (e.g., when a trajectory is finished, a goal position is attained, a particular amount of time passed, etc.). An action can generally control one or more devices or parts of the robot.

In this specification, a framework is a software system that allows a user to provide higher level program definitions while implementing the lower level control functionality of a real-time robotics system. In this specification, the operating environment includes multiple subsystems, each of which can include one or more real-time robots, one or more computing devices having software or hardware modules that support the operation of the robots, or both. The framework provides mechanisms for bridging, communication, or coordination between the multiple systems, including forwarding control parameters from a robot application system, providing sensor measurements to a real-time robotic control system for use in computing the custom action, and receiving hardware control inputs computed for the custom action from the real-time robotic control system, all while maintaining the tight timing constraints of the real-time robot control system, e.g., at the order of one millisecond.

According to a first aspect, there is provided a method that includes: receiving user input that specifies: (i) a real-time session with a robot having a plurality of parts, (ii) a plurality of actions, and (iii) at least one custom reaction that represents a condition under which a first action of the plurality of actions triggers a real-time change in behavior involving a second action of the plurality of actions; generating control parameters from the user input and providing the control parameters to a real-time robotics control layer; and executing, by the real-time robotics control layer, the control parameters including, at each tick of a real-time control cycle: executing one or more respective commands for each of the plurality of actions, determining whether the condition of the first action of the plurality of actions is satisfied, and in response to determining that the condition of the first action of the plurality of actions is satisfied, triggering the real-time change in behavior involving the second action of the plurality of actions.

In some implementations, each action of the plurality of actions causes the real-time robotics control layer to issue the one or more respective commands to different respective parts of the plurality of parts of the robot.

In some implementations, the user input further specifies: (iv) an initial singular action, and (v) a custom reaction associated with the initial singular action that causes the real-time robotics control layer to switch from executing commands associated with the initial singular action to executing commands associated with the plurality of actions.

In some implementations, the initial singular action is associated with commands that cause the plurality of parts of the robot to move together, and wherein each of the plurality of actions is associated with one or more respective commands that cause each part of the plurality of parts of the robot to move independently.

In some implementations, the user input further specifies: (iv) a final singular action, and (v) a custom reaction associated with the plurality of actions that causes the real-time robotics control layer to execute commands associated with the final singular action when the commands associated with the plurality of actions finished executing.

In some implementations, determining whether the condition of the first action of the plurality of actions is satisfied comprises checking a state of the first action.

In some implementations, determining whether the condition of the first action of the plurality of actions is satisfied comprises checking whether the first action has reached a goal state or has otherwise finished execution.

In some implementations, the condition under which the first action of the plurality of actions triggers the real-time change in behavior involving the second action of the plurality of actions depends on a respective state of each of the first action and the second action.

In some implementations, determining whether the condition of the first action of the plurality of actions is satisfied comprises: obtaining one or more sensor measurements characterizing a part of the plurality of parts of the robot to which the real-time robotics control layer issues commands associated with the first action; and determining whether the one or more sensor measurements are above a predetermined threshold.

According to a second aspect, there is provided a system including: one or more computers, and one or more storage devices storing instructions that, when executed by the one or more computers, cause the one or more computers to perform the operations of the method of any preceding aspect.

According to a third aspect, there are provided one or more non-transitory computer storage media storing instructions that when executed by one or more computers cause the one or more computers to perform operations of the method of any preceding aspect.

Particular embodiments of the subject matter described in this specification can be implemented so as to realize one or more of the following advantages.

The framework described in this specification allows a user to define a customized language of real-time reactions that, when executed, is interpreted by the system deterministically in real-time. For example, the system can automatically and seamlessly switch, in real-time, between actions controlling multiple robot parts in a coordinated manner to actions controlling each of the parts individually. Accordingly, the framework described in this specification allows controlling multiple hardware components with real-time guarantees eliminating delays associated with non-real-time processes. Moreover, various robotic applications may require strict synchronization of movements, e.g., as in bimanual interaction of two robotic arms handling a workpiece. By employing real-time control, the framework described in this specification can effectively control various robot parts in synch and mitigate collisions, breakages, and other issues. Furthermore, by employing real-time reaction switching, the framework described in this specification enables synchronized sensor-guided motion that facilitates compliant bimanual manipulation of a single workpiece.

A user of the system described in this specification can provide user input that specifies actions and custom real-time reactions at a non-real-time layer. That is, a user of the system is able to specify, before execution, multiple actions that can influence each other with custom real-time reactions. The system can execute the actions and check on reaction conditions during the control cycle. In this manner, a user of the system can specify custom real-time control information before execution with relatively small amounts of user code, and the system can deterministically interpret the information to control the robot.

Some existing robotics application frameworks dictate the interface of the devices and software modules, and do not allow a user to customize the interfaces for a particular use case, much less a real-time, custom use case. Some systems described in this application allow a user to compose custom software modules that facilitate custom action execution by one or more robots that fit their needs; users can also formulate the data interfaces of the constituent software modules of a real-time robotics control framework. Some such software modules can then be deployed in a control system that allows real-time control of the custom actions while additionally supporting asynchronous programming or streaming inputs or both. A real-time control system is a software system that is required to perform actions within strict timing requirements in order to achieve normal operation.

Under the design of the disclosed real-time robotics control framework, the custom software modules allow a robot to incorporate both real-time sensor information and custom control logic, even in a hard real-time system. Using custom software modules can, in some cases, provide additional capabilities for the robot to react in a more natural and fluid way, which results in higher precision movements, shorter cycle times, and more reliability when completing a particular task. Using custom software modules can also facilitate easy integration with specific robot hardware through a hardware abstraction layer.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system.

FIG. 2 illustrates an example of real-time robotic control using custom reactions.

FIG. 3 illustrates another example of real-time robotic control using custom reactions.

FIG. 4 is a flow diagram of an example process for real-time robotic control using custom reactions.

Like reference numbers and designations in the various drawings indicate like elements.

### DETAILED DESCRIPTION

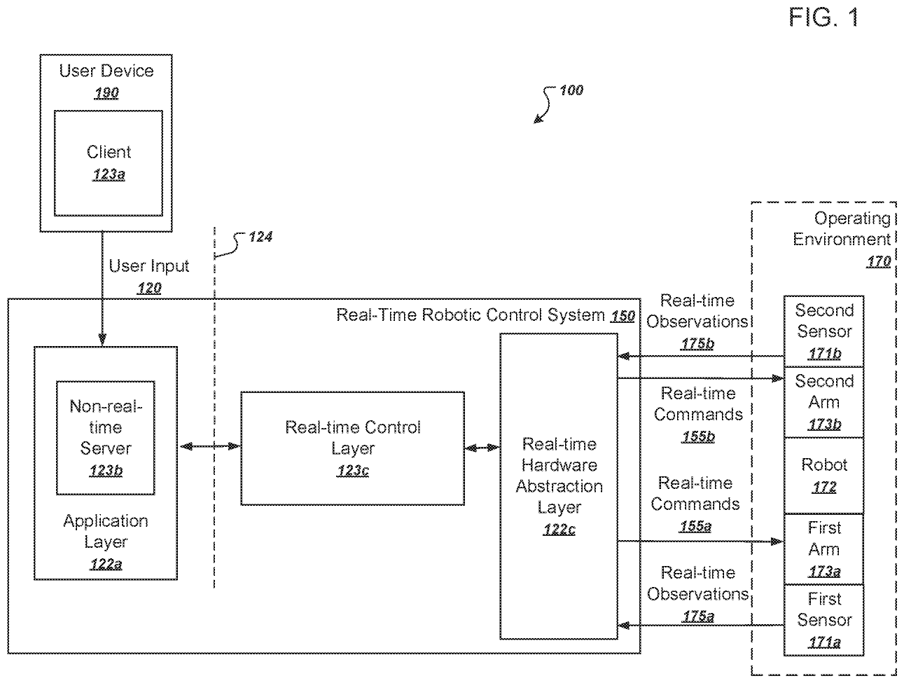

FIG. 1 is a diagram of an example system 100. The system 100 includes a real-time robotic control system 150 to drive a robot 172 in an operating environment 170 (e.g., a workcell). The system 100 includes a number of functional components that can each be implemented as computer programs installed on one or more computers in one or more locations that are coupled to each other through any appropriate communications network, e.g., an intranet or the Internet, or combination of networks.

The system 100 is an example of a system that can implement a real-time robotics control framework as described in this specification. In particular, the system 100 can provide a unified framework that allows users to achieve multiple different types of custom real-time control while simultaneously supporting asynchronous programming or streaming inputs or both. In this specification, a robotic control system being described as being real-time means that it is required to execute within strict timing requirements to achieve normal operation. The timing requirements often specify that certain actions must be executed or outputs must be generated within a particular time window in order for the system to avoid entering a fault state. For brevity, each time window may be referred to as a tick or a control tick. In the fault state, after a tick has elapsed without completing its required computations or actions, the system can halt execution or take some other action that interrupts normal operation, e.g., returning the robots to a starting pose or a fault pose.

In this specification, real-time control being custom means that a user can specify how the robot 172 and/or one or more parts of the robot 172 such as, e.g., a first robot arm 173a, a second robot arm 173b, a gripper, a joint, or any other appropriate part of the robot 172 in the workcell 170, should act or react at each tick of a real-time control cycle.

In particular, as described in more detail below, a user can use a user device 190 to provide user input 120 to an application layer 122a, where the user input 120 specifies: (i) a real-time session with the robot 172, (ii) multiple actions, and (iii) at least one custom reaction that represents a condition under which a first action triggers a real-time change in behavior involving a second action. Generally, an “action” refers to a motion having precomputed motion parameters, such as moving the first robot arm 173a from point A to point B. Each action can define how a respective part of the robot (e.g., the first arm 173a, the second arm 173b, a gripper, a joint, any other appropriate part of the robot 172, or a combination thereof) should move at each tick of the real-time control cycle. In some cases, a user can specify an action that defines how multiple parts of the robot 172 (e.g., the first arm 173a and the second arm 173b) should act together. Generally, a “custom reaction” refers to a user-specified condition for a real-time switch between, or a change in behavior of, one or more actions. In some cases, the condition can include, e.g., sensor data that is updated in real-time, or any other appropriate user-defined condition. The system 100 can further allow users to specify custom real-time control parameters defined by, e.g., custom real-time control code, that are executed to recompute motion parameters on the fly at each tick of the real-time control cycle, as opposed to issuing low-level commands according to precomputed motion parameters.

A user can use the user device 190 to provide the user input 120 to the application layer 122a. The user device 190 can for example execute an integrated development environment (IDE) that is compatible with the real-time robotic control system 150. An IDE is a software suite providing tools facilitating users to write and, optionally, test software for deployment in the real-time robotic control system 150. A user can develop custom software applications in an editor of the IDE. For example, the user can write code, e.g., class, object, or method instances that are required to facilitate the real-time control of the robot 172 to perform a custom action. The system 150 can also prompt the user to write code for different software modules, or different components of a single software module, to be included in the control stack 122. A class is a combination of methods and data that are encapsulated in a file that defines how data are stored and accessed. A class may form a template from which instances of running code may be created or instantiated. An object or code object is code that may be interpreted, compiled, or both. An object may be an example of a class once instantiated for a specific purpose.

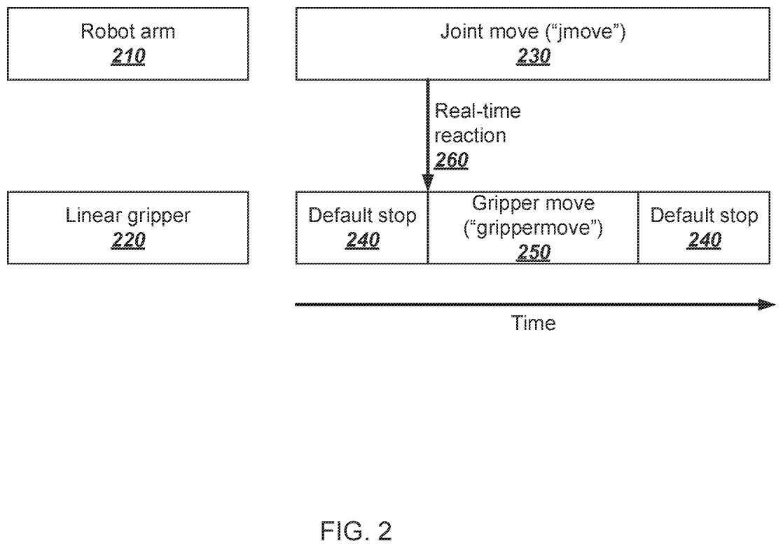

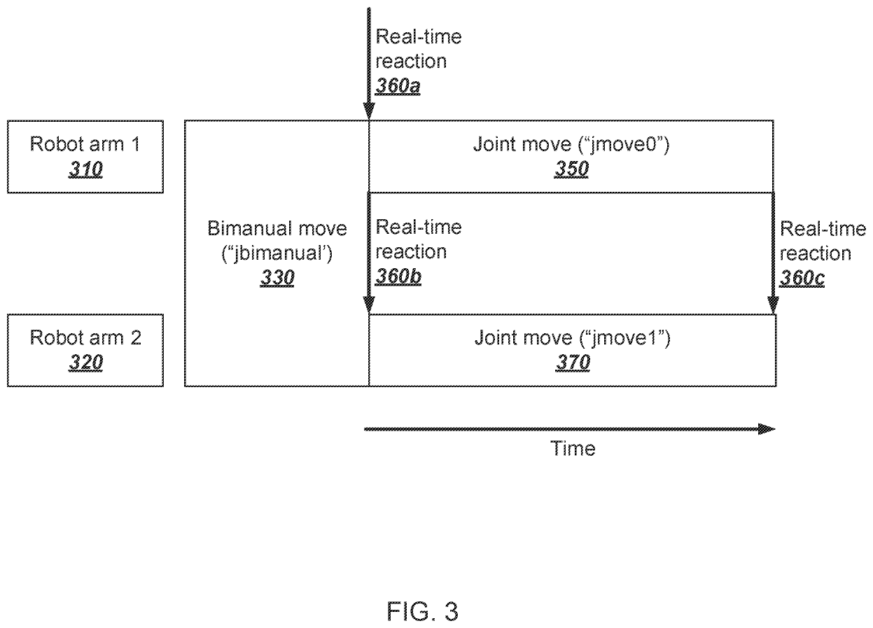

An advantage of the framework provided by the system 100 is that it can allow users to specify such custom real-time control information with relatively small amounts of user code, which can be expressed in high-level programming languages, e.g., Object Oriented Programming (OOP) languages, including C++, Python, Lua, and Go, to name just a few examples. This capability for providing high-level, custom real-time control is vastly easier and more powerful than programming robot movements using only low-level commands that relate to joint angles or levels of electrical current. Example user code is described in more detail below with reference to FIG. 2 and FIG. 3.

The real-time robotic control system 150 can generate custom real-time control parameters based on the user input 120 and execute the control parameters to control the robot 172. In some cases, the control parameters can be defined by, e.g., custom real-time control code. Different custom real-time control parameters can be executed in different layers of a control stack, e.g., in the client 123a, the non-real-time server 123b, the real-time control layer 123c, or some combination of these.

Generally, the control stack of the real-time robotic control system 150 follows a client-server model in which a client 123a provides commands to the non-real-time server 123b, which handles passing commands over a boundary 124 between real-time and non-real-time code. The non-real-time server 123b may execute on a common computer with the client 123a, or operate on a different computer. This arrangement allows the non-real-time server 123b to implement custom real-time reactions that cause the real-time control layer 123c to switch execution, and/or trigger a change in behavior, of actions in real-time. Thus, the real-time server 123b can be responsible for determining at which control cycle the real-time reaction should occur.

The real-time robotic control system 150 is then configured to control the robot 172 in the operating environment 170 according to the custom real-time control parameters generated based on the user input 120. To control the robot 1720 in the operating environment 170, the real-time robotic control system 150 provides commands 155 to be executed by the robot 172 in the operating environment 170. The real-time robotic control system 150 can provide commands through the control stack 122 that handles providing real-time control commands 155 to the robot 172. In some cases, the control stack 122 can be implemented as a software stack that is at least partially hardware-agnostic. In other words, in some implementations the software stack can accept, as input, commands generated by the control system 150 without requiring the commands to relate specifically to a particular model of robot or to a particular robotic component.

The control stack 122 includes multiple levels, with each level having one or more corresponding software modules. In FIG. 1, the lowest level is the real-time hardware abstraction layer 122c, and the highest level is the application layer 122a. Some of the software modules 122a-c can be high-level software modules composed of one or more lower-level software modules and a data interface, generated by the user using the lower-level software modules. That is, a custom high-level software module can depend on one or more low-level software modules.

The control stack 122 ultimately drives robot components in the operating environment 170 by executing the control parameters generated by the system 150 based on the user input 120. In some cases, the client 123a can provide the definition of the custom real-time action to the non-real-time server 123b, which can then initialize all the motion parameters and other state variables for real-time execution. For example, the non-real-time server 123b can preallocate memory and perform data format conversions between non-real-time data formats and real-time data formats. The client 123a can then provide a start command to the non-real-time server 123b, which kicks off execution of the custom real-time action using the real-time control layer 123c.

As described above, the user input 120 can specify multiple actions and at least one custom reaction that represents a condition under which a first action triggers a real-time change in behavior involving a second action. In some cases, as described in more detail below, each action can cause the real-time robotics control layer 123c to issue the one or more respective commands 155 to different parts of the robot. In other words, each action can be associated with one or more robot parts, e.g., the first arm 173 of the robot 172, the second arm 173b of the robot 172, any other appropriate part of the robot 172, or a combination thereof. That is, each action can define a motion plan with precomputed motion parameters for the respective one or more parts of the robot 172. In some cases, the robot 172 can include a variety of low-level components including motors, encoders, cameras, drivers, grippers, application-specific sensors, linear or rotary position sensors, and other peripheral devices. In some cases, each action can be associated additionally, or alternatively, with one or more of these components in the operating environment 170.

The real-time robotics control layer 123c can execute the control parameters at each tick of the real-time control cycle. Specifically, at each tick of the real-time control cycle, the real-time control layer 123c can execute one or more respective commands 155 for each of multiple actions. For example, a first action can specify a motion of the first arm 173a having precomputed motion parameters. The real-time control layer 123c can issue a command 155a to the first arm 173a of the robot 172 to drive the movement of the first arm 173a. A second action can specify a motion of the second arm 173b of the robot 172, and the real-time robotics control layer can similarly issue a command 155b to the second arm 173b of the robot 172 to drive the movement of the second arm 173b.

As described above, in some cases, the user input 120 can further specify a custom real-time reaction. Generally, a custom reaction can represent a condition under which a first action (e.g., movement of the first arm 173a) triggers a real-time change in behavior involving a second action (e.g., triggers the movement of the second arm 173b). The condition can be any appropriate condition and can be defined by a user of the system 100. In one example, the condition can depend on a state of the first action, e.g., whether the first action has reached a goal state or otherwise finished executing. As a particular example, the condition can be, e.g., a threshold amount of torque applied by the first arm 173a. At each tick of the real-time control cycle, the real-time robotics control layer 123c can determine whether the condition of the first action is satisfied. In response to determining that the condition of the first action is satisfied, the real-time robotics control layer 123c can trigger the real-time change in behavior involving the second action. For example, the real-time robotics control layer 123c can determine that the torque applied by the first arm 173a is above the threshold. In response, the real-time robotics control layer 123c can automatically issue the command 155b to the second arm 173b to trigger the movement of the second arm 173b.

In some cases, in order to determine whether the condition of the first action is satisfied, the real-time robotic control system 150 can consume observations 175a, 175b made by one or more sensors (e.g., sensors 171a, 171b) gathering data within the operating environment 170. As illustrated in FIG. 1, each sensor 171 is coupled to a respective robotic component, e.g., the first arm 173a and the second arm 173b. However, the sensors 171 need not have a one-to-one correspondence with the parts of the robot 172 and need not be coupled to the robot 172. Generally, the parts of the robot 172 can have multiple sensors 171, and the sensors 171 can be mounted on stationary or movable surfaces in the operating environment 170. Any suitable sensors 171 can be used, such as distance sensors, force sensors, torque sensors, cameras, or any other appropriate sensors.

As described above, custom reactions can be used to define real-time transition between two real-time actions according to one or more conditions. For example, two movement actions can be chained together by associating a first action with a reaction condition that represents, e.g., the end of the first action, or any other appropriate condition. When the condition is satisfied, the real-time control layer 123c can automatically and in real time switch to performing the second action. In other words, the real-time control layer 123c need not wait for confirmation or an instruction from a higher-level controller to begin execution of the second action. In some cases, the real-time robotic control layer 123c can continue executing the first action after the second action has been triggered, e.g., can execute the first action and the second action in parallel.

Furthermore, each action does not necessarily correspond to movement of a single part of the robot. For example, some actions can be defined with respect to (e.g., simultaneous and/or coordinated) movement of two or more components, e.g., bimanual movement of both arms of the robot 173a and 173b. As a particular example, a single action can define, e.g., coordinated movement of both arms of the robot, one with relatively high impedance and the other with relatively low impedance to achieve bimanual interaction. The single action can be associated with a reaction condition that represents, e.g., the end of the single action. When the condition is satisfied, the real-time control layer 123c can automatically and in real-time switch from executing the single action (e.g., bimanual movement of both arms) to executing one or more other actions, e.g., to control only the first arm 173c, only the second arm 173b, or both arms 173a and 173b independently. This example is described in more detail below with reference to FIG. 3.

As another particular example, a single action can define, e.g., a coordinated movement of a robotic arm and a conveyor belt. The single action can control, e.g., a motion of the robotic arm picking an object from the conveyor belt and, at the same time, a speed of the conveyor belt. In this manner, the single action can adjust the speed of the conveyor belt depending on the trajectory of the robotic arm when it is approaching the object on the conveyor belt. When a real-time reaction condition associated with the single action is satisfied, e.g., the robotic arm successfully picks up the object from the conveyor belt, the real-time control layer 123c can automatically switch from executing the single action to executing one or more other actions, e.g., to control the robotic arm and the conveyor belt independently.

The specifics of timing constraints and the flexibility related to timing windows are generally configurable aspects of the real-time robotic control system 150 that can be tailored for the task being performed. The real-time requirements of the system 150 can be, e.g., that the hardware abstraction layer 122c provide a command at a first rate (or frequency), e.g., every 5, 10, or 20 milliseconds, while the non-real-time requirements of the system 150 can specify that the control layer 123c should provide a command to the hardware abstraction layer 122c at a second rate that is often lower than the first rate, e.g., every 25, 50, or 100 milliseconds. In addition, the rates need not be fixed. For example, the hardware abstraction layer 122c can provide a command at a fixed rate, while the application layer 122a can provide a command at a varying rate or a rate that is sporadic.

To bridge the boundary between the non-real-time commands generated by upper-level software modules in the control stack 122 and the real-time commands generated by the lower-level software modules in the control stack 122, the real-time robotic control system 150 can use the control layer 123c and a non-real-time server 123b that collectively facilitate real-time control of a custom action from commands issued by the client 123a. The control layer 123c serves as a bridging module in the control stack that translates each non-real-time command into data that can be consumed by real-time controllers that are responsible for generating low-level real-time commands. Such low-level real-time commands can, for example, relate to the actual levels of electrical current to be applied to robot motors and actuators at each point in time in order to effectuate the movements specified by the command. For each custom real-time action, some of all of the constituent software modules of the control layer, including constituent software modules of the real-time control module within the control layer, may be developed by a user. Once developed, the constituent software modules may be provided in the form of one or more application programming interfaces (APIs) and may orchestrate with those within the application module to facilitate custom real-time control of the robots.

Another powerful feature of the framework described in this specification is the integration of real-time sensor data into the mechanisms of custom real-time control. One way of doing this is to have the conditions associated with custom real-time reactions depend on sensor data. For example, a user can define a custom real-time reaction associated with a first action, which controls the first robot arm 173a, that triggers motion of the second arm 173b when the first arm 173a comes in contact with a surface. To do so, the user can define a condition based on a force sensor 171a coupled to the first arm 173a such that when the force as measured by the force sensor 171a exceeds a particular threshold, the real-time control layer 123c can automatically and in real-time trigger the motion of the second arm 173b.

The framework described in this specification allows a user to define a customized language of real-time reactions that, when executed, is interpreted by the system deterministically in real-time. For example, the system can automatically and seamlessly switch, in real-time, between actions controlling multiple robot parts in a coordinated manner to actions controlling each of the parts individually. Accordingly, the framework described in this specification allows controlling multiple hardware components with real-time guarantees eliminating delays associated with non-real-time processes.

FIG. 2 illustrates an example of real-time robotic control using custom reactions. The example illustrated in FIG. 2 can be implemented by the real-time robotic control system 150 described above with reference to FIG. 1.

As described above with reference to FIG. 1, the real-time robotic control system can control a robot having multiple parts in an operating environment. In the example of FIG. 2, the robot includes two parts: a robot arm 210 and a linear gripper 220. A user of the real-time robotic control system can provide an input to the system that specifies: (i) a real-time session with the robot, (ii) multiple actions, and (iii) at least one custom reaction that represents a condition under which a first action triggers a real-time change in behavior involving a second action.

As illustrated in FIG. 2, the first action can be joint move 230 (“jmove”), e.g., the first action causes movement of a joint of the robot arm 210, and the second action can be gripper move 250 (“grippermove”), e.g., the second action causes the linear gripper 220 of the robot to open. The actions can further include one or more default actions, e.g., a default stop 240 that causes the part of the robot associated with the action to remain motionless. In the example illustrated in FIG. 2, the custom real-time reaction 260 associated with the joint move action 230 causes the real-time robotic control layer to trigger a real-time change in behavior of the linear gripper 220, e.g., to cause the linear gripper 220 to switch from the default stop 240 action to the gripper move 250 action in real-time.

As described above with reference to FIG. 1, the real-time robotic control system can allow users to specify custom real-time control information by providing user input with relatively small amounts of user code, which can be expressed in high-level programming languages. An example user code for execution of real-time robotic control illustrated in FIG. 2 is shown in TABLE 1.

TABLE 1

| | |
|---|---|
| 1 | auto grippermove = MakeGripperMove({gripper},{0}); |
| 2 | auto jmove = MakeJointMove({robot}, goal); |
| 3 | |
| 4 | session.RunActions({ |
| 5 | grippermove.WithReaction( |
| 6 | WaitSeconds(1).WithRealTimeReaction(jmove.ld( ))), |
| 7 | jmove |
| 8 | }); |

As described above with reference to FIG. 1, the system can generate control parameters based on user input, e.g., the input shown in TABLE 1. The real-time robotics control layer can execute the control parameters at each tick of a real-time control cycle. Specifically, at each tick of the real-time control cycle, the real-time robotics control layer can execute the joint move 230 action of the robot arm 230 and determine whether the condition of the joint move 230 action is satisfied. As indicated in TABLE 1, “WaitSeconds(1)” represents the custom real-time reaction that defines the condition associated with the joint move 230 action, e.g., to wait for 1 second to elapse. At each tick of the real-time control cycle, the real-time robotics control layer can determine whether the condition is satisfied.

If the real-time robotics control layer determines that the condition is not satisfied, the real-time robotics control layer can continue executing the joint move 230 action of the robot arm 230. If the real-time robotics control layer determines that the condition is satisfied, the real-time robotics control layer can trigger the gripper move 250 action, e.g., to cause the linear gripper 220 to switch, automatically and in real-time, from the default stop 240 action to the gripper move 250 action. That is, the real-time robotics control layer can cause the linear gripper 220 to perform the gripper move 250 action while the robot arm 210 performs the joint move 230 action, e.g., simultaneously, or in parallel. After the gripper move 250 action finished executing, the real-time robotics control layer can cause the linear gripper 220 to automatically return to the default stop 240 action.

FIG. 3 illustrates another example of real-time robotic control using custom reactions. The example illustrated in FIG. 3 can be implemented by the real-time robotic control system 150 described above with reference to FIG. 1.

In the example of FIG. 3, the robot includes two parts: a first robot arm 310 and a second robot arm 320. As described above with reference to FIG. 1 and FIG. 2, the real-time robotic control system can generate control parameters based on user input. In some cases, the user input can specify: (i) an initial singular action, and (ii) a custom reaction associated with the initial singular action that causes a real-time robotics control layer included in the system to switch from executing commands associated with the initial singular action to executing commands associated with multiple actions.

As illustrated in FIG. 3, the initial singular action can be bimanual move 330 (“jbimanual”), e.g., the initial singular action can cause bimanual coordinated joint movement of both the first robot arm 310 and the second robot arm 320. The other actions can be joint move 350 (“jmove0”) that causes independent joint movement of the first robot arm 310, and joint move 370 (“jmove1”) that causes independent joint movement of the second robot arm 320. In other words, the initial singular action 330 can cause coordinated movement of both robot arms, while each of the other actions can cause independent movement of the respective robot arm.

In the example illustrated in FIG. 3, the custom real-time reaction 360a associated with the bimanual move 330 action causes the real-time robotic control layer to trigger a real-time change in behavior of both the first robot arm 310 and the second robot arm 320. Specifically, the real-time reaction 360a causes the real-time robotic control layer to switch from executing the singular bimanual move 330 action associated with coordination movement of both arms 310, 320 to executing independent joint move actions 350, 370 of each of the arms 310, 320, respectively. In this manner, the real-time robotics control layer can switch from executing bimanual coordinated movement of both arms to executing independent movement of each of the arms.

In some cases, the custom real-time reaction 360a associated with the bimanual move 330 action can cause the real-time robotic control layer to switch the first robot arm 310 from performing the bimanual move 330 action to joint move 350 action of the first arm 310. The joint move 350 action of the first arm 310 can itself be associated with a second custom real-time reaction 360b that instantaneously causes the real-time robotic control layer to switch the second robot arm 320 from performing the bimanual move 330 action to performing the joint move 370 action of the second arm 320. In this manner, the real-time robotics control layer can seamlessly switch from executing bimanual coordinated movement of both the first robot arm 310 and the second robot arm 320, to independent movement of each of the arms 310, 320.

The custom real-time reaction 360c can be associated with both joint move 350 action of the first arm 310 and joint move action 370 of the second arm 320. In other words, when both actions 350, 370 finished executing, the real-time robotics control layer can trigger both arms 310, 320 to switch to a default stop action.

An example user code for execution of real-time robotic control illustrated in FIG. 3 is shown in TABLE 2.

TABLE 2

| | |
|---|---|
| 1 | auto jbimanual = MakeJointMove( |
| 2 | {robot0, robot1},{goal00, goal01}); |
| 3 | |
| 4 | auto jmove0 = MakeJointMove({robot0},{goal10}); |
| 5 | auto jmove1 = MakeJointMove({robot1},{goal11}); |
| 6 | auto done = MakeStop( ); |
| 7 | |
| 8 | session.RunActions({ |
| 9 | jbimanual.WithReaction( |
| 10 | WhenDone( ).WithRealTimeReaction(jmove0.ld( ))), |
| 11 | jmove0.WithReaction( |
| 12 | Immediately( ).WithRealTimeReaction(jmove1.ld( ))), |
| 13 | jmove1.WithReaction(And(WhenDone( ), |
| 14 | jmove0.WhenDone( )).WithRealTimeReaction(done.ld( ))), |
| 15 | done |
| 16 | }); |

In the user code shown in TABLE 2, the bimanual move 330 action (“jbimanial”) finishes executing when the first robot arm 310 (“robot0”) reaches a goal state “goal00,” and the second robot arm 320 (“robot1”) reaches a goal state “goal01.” The joint move 350 action of the first arm 310 finishes executing when the first robot arm 310 (“robot0”) reaches a goal state “goal10.” The joint move 370 action of the second arm 320 finishes executing when the second robot arm 320 (“robot1”) reaches a goal state “goal11.” Generally, the goal state of a robot arm can be characterized in any appropriate manner. In one example, the goal state can represent a particular position and/or orientation of a joint of the robot arm. The term “WithRealTimeReaction” associates a particular custom real-time reaction with a particular action. For example, the reaction associated with the “jbimanual” action is that, when the action finishes executing, e.g., “WhenDone( ),” the system automatically triggers the “jmove0” action. “Immediately( )” indicates that, when the “jmove0” action is triggered, the system automatically triggers “jmove1” action.

An example process for real-time robotic control using custom reactions is described in more detail next.

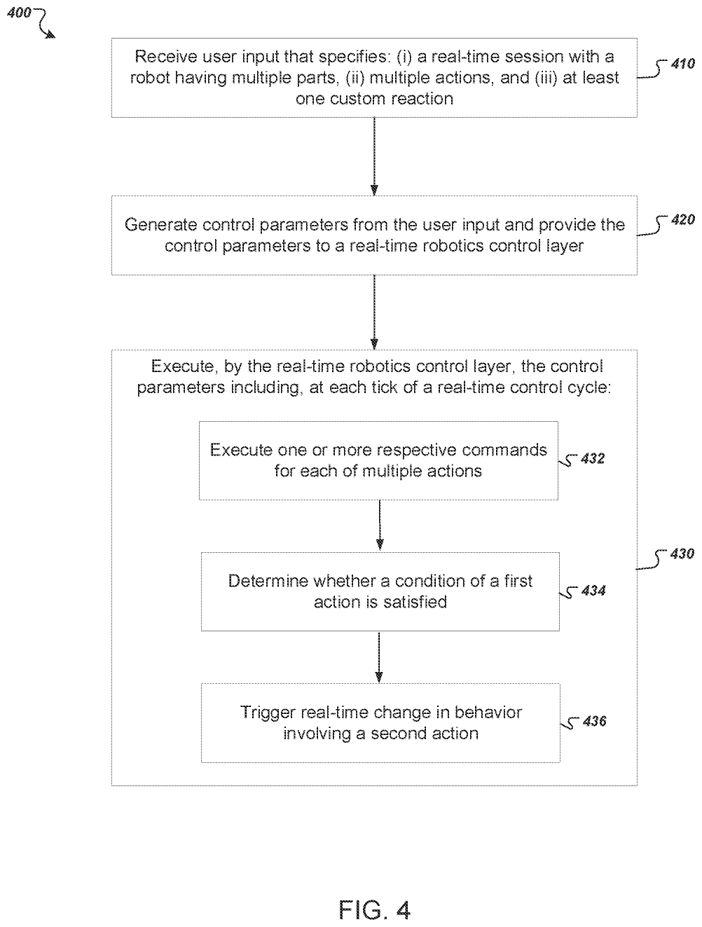

FIG. 4 is a flowchart of an example process for real-time robotic control using custom reactions. The process can be implemented by one or more computer programs installed on one or more computers and programmed in accordance with this specification. For example, the process can be performed by the real-time robotic control system 150 shown in FIG. 1. For convenience, the process will be described as being performed by a system of one or more computers.

The system receives user input that specifies: (i) a real-time session with a robot having multiple parts, (ii) multiple actions, and (iii) at least one custom reaction that represents a condition under which a first action triggers a real-time change in behavior involving a second action (410). As described above with reference to FIG. 1, a user can provide user input through a user device. Example user inputs are described in more detail above with reference to FIG. 2 and FIG. 3. In some cases, the condition under which the first action triggers the real-time change in behavior involving the second action depends on a respective state of each of the first action and the second action.

The system generates control parameters from the user input and provides the control parameters to a real-time robotics control layer (420). In some cases, each action can cause the real-time robotics control layer to issue one or more respective commands to different parts of the robot. For example, a first action can define a motion of a robot arm having precomputed motion parameters. A second action can define a motion of a gripper coupled to the robot arm. The real-time robotics control layer can issue a first set of commands to the arm and a second set of commands to the gripper.

The system executes, by the real-time robotics control layer, the control parameters (430). In particular, the system executes one or more respective commands for each of multiple actions (432). The system determines whether the condition of the first action is satisfied (434). For example, the system can check a state of the first action. In some cases, the system can check whether the first action has reached a goal state or has otherwise finished execution. In some cases, the system can obtain one or more sensor measurements characterizing a part of the robot to which the real-time robotics control layer issues commands associated with the first action, and determining whether the one or more sensor measurements are above a predetermined threshold.

In response to determining that the condition of the first action is satisfied, the system triggers a real-time change in behavior involving the second action (436).

In some cases, the user input can further specify: (iv) an initial singular action, and (v) a custom reaction associated with the initial singular action that causes the real-time robotics control layer to switch from executing commands associated with the initial singular action to executing commands associated with the actions. The initial singular action can be associated with commands that cause the parts of the robot to move together. Each of the other actions can be associated with one or more respective commands that cause each part of the robot to move independently. For example, the initial singular action can be a bimanual joint move action that defines a coordinated motion of two robot arms. The custom reaction can cause the real-time robotics control layer to switch from executing commands associated with the bimanual move action to executing commands associated with two joint move actions each of which independently moves a respective arm of the robot.

In some cases, user input can further specify: (iv) a final singular action, and (v) a custom reaction associated with multiple actions that causes the real-time robotics control layer to execute commands associated with the final singular action when the commands associated with the other actions finished executing. For example, after the execution of each action associated with a respective robot arm is finished, the custom reaction can cause the real-time robotics control layer to execute commands associated with the default stop action where both robot arms remain motionless.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an operating environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
receiving user input that specifies:
(i) a real-time session with a robot having a plurality of parts,
(ii) a plurality of actions, and
(iii) at least one custom reaction that represents a condition under which a first action of the plurality of actions triggers a real-time change in behavior involving a second action of the plurality of actions;
generating control parameters from the user input and providing the control parameters to a real-time robotics control layer; and
executing, by the real-time robotics control layer, the control parameters including, at each tick of a real-time control cycle:
executing one or more respective commands for each of the plurality of actions,
determining whether the condition of the first action of the plurality of actions is satisfied, and
in response to determining that the condition of the first action of the plurality of actions is satisfied, triggering the real-time change in behavior involving the second action of the plurality of actions.

2. The method of claim 1, wherein each action of the plurality of actions causes the real-time robotics control layer to issue the one or more respective commands to different respective parts of the plurality of parts of the robot.

3. The method of claim 1, wherein the user input further specifies:
(iv) an initial singular action, and
(v) a custom reaction associated with the initial singular action that causes the real-time robotics control layer to switch from executing commands associated with the initial singular action to executing commands associated with the plurality of actions.

4. The method of claim 3, wherein the initial singular action is associated with commands that cause the plurality of parts of the robot to move together, and wherein each of the plurality of actions is associated with one or more respective commands that cause each part of the plurality of parts of the robot to move independently.

5. The method of claim 1, wherein the user input further specifies:
(iv) a final singular action, and
(v) a custom reaction associated with the plurality of actions that causes the real-time robotics control layer to execute commands associated with the final singular action when the commands associated with the plurality of actions finished executing.

6. The method of claim 1, wherein determining whether the condition of the first action of the plurality of actions is satisfied comprises checking a state of the first action.

7. The method of claim 1, wherein determining whether the condition of the first action of the plurality of actions is satisfied comprises checking whether the first action has reached a goal state or has otherwise finished execution.

8. The method of claim 1, wherein the condition under which the first action of the plurality of actions triggers the real-time change in behavior involving the second action of the plurality of actions depends on a respective state of each of the first action and the second action.

9. The method of claim 1, determining whether the condition of the first action of the plurality of actions is satisfied comprises:
obtaining one or more sensor measurements characterizing a part of the plurality of parts of the robot to which the real-time robotics control layer issues commands associated with the first action; and
determining whether the one or more sensor measurements are above a predetermined threshold.

10. A system comprising:
one or more computers, and
one or more storage devices storing instructions that when executed by the one or more computers cause the one or more computers to perform operations comprising:
receiving user input that specifies:
(i) a real-time session with a robot having a plurality of parts,
(ii) a plurality of actions, and
(iii) at least one custom reaction that represents a condition under which a first action of the plurality of actions triggers a real-time change in behavior involving a second action of the plurality of actions;
generating control parameters from the user input and providing the control parameters to a real-time robotics control layer; and
executing, by the real-time robotics control layer, the control parameters including, at each tick of a real-time control cycle:
executing one or more respective commands for each of the plurality of actions,
determining whether the condition of the first action of the plurality of actions is satisfied, and
in response to determining that the condition of the first action of the plurality of actions is satisfied, triggering the real-time change in behavior involving the second action of the plurality of actions.

11. The system of claim 10, wherein each action of the plurality of actions causes the real-time robotics control layer to issue the one or more respective commands to different respective parts of the plurality of parts of the robot.

12. The system of claim 10, wherein the user input further specifies:
(iv) an initial singular action, and
(v) a custom reaction associated with the initial singular action that causes the real-time robotics control layer to switch from executing commands associated with the initial singular action to executing commands associated with the plurality of actions.

13. The system of claim 12, wherein the initial singular action is associated with commands that cause the plurality of parts of the robot to move together, and wherein each of the plurality of actions is associated with one or more respective commands that cause each part of the plurality of parts of the robot to move independently.

14. The system of claim 10, wherein the user input further specifies:
(iv) a final singular action, and
(v) a custom reaction associated with the plurality of actions that causes the real-time robotics control layer to execute commands associated with the final singular action when the commands associated with the plurality of actions finished executing.

15. The system of claim 10, wherein determining whether the condition of the first action of the plurality of actions is satisfied comprises checking a state of the first action.

16. The system of claim 10, wherein determining whether the condition of the first action of the plurality of actions is satisfied comprises checking whether the first action has reached a goal state or has otherwise finished execution.

17. The system of claim 10, wherein the condition under which the first action of the plurality of actions triggers the real-time change in behavior involving the second action of the plurality of actions depends on a respective state of each of the first action and the second action.

18. The system of claim 10, determining whether the condition of the first action of the plurality of actions is satisfied comprises:
obtaining one or more sensor measurements characterizing a part of the plurality of parts of the robot to which the real-time robotics control layer issues commands associated with the first action; and
determining whether the one or more sensor measurements are above a predetermined threshold.

19. One or more non-transitory computer storage media storing instructions that when executed by one or more computers cause the one or more computers to perform operations comprising:
receiving user input that specifies:
(i) a real-time session with a robot having a plurality of parts,
(ii) a plurality of actions, and
(iii) at least one custom reaction that represents a condition under which a first action of the plurality of actions triggers a real-time change in behavior involving a second action of the plurality of actions;
generating control parameters from the user input and providing the control parameters to a real-time robotics control layer; and
executing, by the real-time robotics control layer, the control parameters including, at each tick of a real-time control cycle:
executing one or more respective commands for each of the plurality of actions,
determining whether the condition of the first action of the plurality of actions is satisfied, and
in response to determining that the condition of the first action of the plurality of actions is satisfied, triggering the real-time change in behavior involving the second action of the plurality of actions.
